(19) United States
(12) Patent Application Publication
(10) Pub. No.: US 2008/0210654 A1
(43) Pub. Date: Sep. 4, 2008

(54) Trolley for loading

(76) Inventor: Kouzo Kataoka, Osaka (JP)

Correspondence Address: THOMPSON HINE L.L.P.;Intellectual Property Group, P.O. BOX 8801, DAYTON, OH, 45401-8801, US

(21) Appl. No.: 11/881,265

(22) Filed: Jul. 26, 2007

(30) Foreign Application Priority Data
Jul. 28, 2006 (JP) 2006-206686
Jun. 25, 2007 (JP) 2007-166077

(51) Int. Cl. B66C 11/16

(52) U.S. Cl. 212/346

(57) ABSTRACT

The object of the present invention is to provide a trolley for loading able to comply with a force other than a direction of movement based on a premise of usage of a circular pipe as a rail. The present invention is a single-track suspension trolley for loading applied to a single rail, of which at least an upper half part is formed in arch, having a V-shaped groove having symmetric taper planes slanting to a center at midspan, having a drum-shaped wheel running on the rail while the taper plane of the V-shaped groove is in a contact condition with the upper half part in two points, having a flame provided with a pivot side plate enabling to roll the wheel, and having a cargo handling member provided with the flame beneath the wheel. A wheel is connected integrally with a pair of piece having a conical surface, each of which is faced or a V-shaped groove is produced at a center of a cylindrical member by abrading thereof. Further, a wheel is formed from a material such as a rubber and a synthetic resin having a sound absorption effect of a rolling noise.

### BACKGROUND OF THE INVENTION

1. Field of the Invention

The present invention relates to a trolley hauling up a load and carrying to a destination along a rail, and in detail, a single-track suspension trolley utilizing a circular pipe as a rail.

2. Description of the Related Art

A trolley is used for a purpose to transfer a load in a lifted condition by a hoist and such as along with a prepared rail set in mid air, especially, in an indoor environment such as a warehouse and a manufacturing facility where a crane vehicle or a lift car is difficult to operate. As a rail, a large-scaled steel such as I-section steel, H-section steel or C-section steel having high load bearing characteristics is used considering a moving distance and a weight of a load. There are trolleys meet to shapes of steels (refer to a nonpatent literature 1). Also, a joist of a building is used for a rail.

On the other hand, a trolley utilizing a circular pipe is public knowledge (patent document 1).
[Nonpatent literature] “H.H.H. union catalogue Vol. 5” H.H.H. Co. Ltd. Jul. 30, 2005. PP15˜16
[Patent document 1] Japanese published unexamined application No. 10-182064

Among the prior arts, a trolley utilizing a large-scaled steel as a rail is suitable to transfer a load of several hundred to several thousand kilogram for a relatively long distance while the trolley does not have a small turning circle to transfer a relatively lightweight load for a short distance. Also, utilizing a large-scaled steel as a rail results in a large construction of a rail and change of layout afterward is virtually impossible. In the first place, a large-scaled steel has a considerable weight thereof and therefore, when a rail is constructed, an intensity of a building has to be high. Accordingly, an applicable scope of a trolley is limited to a large facility.

Compared with this, a trolley in the patent document 1 utilizes a circular pipe as a rail which enables to have a small turning circle, and construct or change of a layout flexibly. Further, the circular pipe is easily obtained and lightweight compared to a large-scaled steel. Therefore, the trolley is used naturally in a large facility and for example, in a nursing-care facility or a house to assist a person in need of nursing care.

However, the trolley in the patent document 1 utilizing a circular pipe as a rail constructs a rail with two circular pipes parallel to above and below and since the trolley is composed of a wheel to be put on an upper pipe and a pair of guide roller sandwiching a lower pipe, a composition is complex. Further, as a fluctuation and rotation of the trolley is completely constrained by the guide roller, when a force other than direction of movement is put, stress is placed on the rail and trolley cannot be compliance with the force. As the guide roller clamps the lower pipe, the trolley cannot be use when a diameter of the lower pipe is changed. In this point, a composition of a clearance of a guide roller changeable according to a diameter of a lower pipe can be adopted. However, a composition becomes complex, manipulation is to be difficult, and a manufacturing cost increases.

A problem stated as to a trolley in the patent document 1 is common to the trolley utilizing a large-scaled steel as a rail. A trolley applied to a I-section steel or a H-section steel also has a composition to clamp a web with a pair of wheel of right and left. A trolley applied to a C-section steel has a composition wherein a pair of wheel of right and left is stored in a channel. In each case, a fluctuation and rotation of the trolley is constrained and also each case has a problem of a clearance adjustment of a wheel.

### SUMMARY OF THE INVENTION

The present invention is devised in consideration of the above problem. An object of the invention is to provide a trolley for loading compliant to a force other than direction of movement based on a premise that a construction and alteration of a layout is easy and a circular pipe, which is easily obtained and widely applied, is to be used.

To achieve the above object, for the first means, the present invention employs a means of a trolley construction, wherein a single-track suspension trolley for loading applied to a single rail, of which at least an upper half part is formed in arc shape, comprising: a flame which has a drum-shaped wheel having a V-shaped groove provided at a middle portion thereof to be contact in two points with the upper half part of the rail and running on the rail, and a pair of side plates supporting the wheel rotationally; and a cargo handling member provided with the flame beneath the wheel. The wheel functions to move the trolley along the rail. As this wheel is two-point mounting on the rail, when a force in an oblique or lateral direction towards a direction of movement is produced, a position can be altered according to the force. Therefore, a number of a wheel provided with a direction of movement can be more than two. As a premise of the present invention, a rod stock at least an upper half part thereof formed in arc shape is used as the rail. A circular pipe is used as the rod stock and also an arched pipe produced by halving a circular pipe can be used. In each case, the rail has to have a withstand load according to an intended purpose.

In this first means, the V-shaped groove has preferably symmetric taper planes and a horizontal plane between the taper planes. As the wheel composition, mainly, a pair of cones having a conical surface and connected with the conical surfaces of the cones faced each other. Also, the V-shaped groove is produced at a center of a cylindrical member by carving thereof. Accordingly, the former is composed by a combination of plural parts and therefore, forming can be exercised without waste. Further, this former means includes both composition of connecting a pair of piece directly and connecting a pair of piece with an axial region. On the other hand, a composition of the latter means is to carve a cylindrical member. In this case, although carved part is to be wasted, an assembly process is not needed.

In the present invention, the flame is to integrate the wheel with the cargo handling member and the cargo handling member is to suspend a cargo appliance such as a hoist and a chain block. As long as these functions are bore, a composition is not to be limited. The flame in the first means is preferably formed by having a horizontal member connecting upper ends of the side plates for providing an opening at lower part thereof, and the cargo handling member is preferably provided at a lower end of one of the side plates. The cargo handling member is composed of a hook with the simplest way and also has a depressed portion formed by bending a center of a rod stock. One end thereof is preferably attached detachably to one of the side plates of the flame enabling the depressed portion to be openable. The above composition is preferred to adopt. Apart from this, an alternate composition is as follows. The cargo handling member comprises a piece of U-shaped work providing shaft holes at both ends thereof. The flame comprises connecting rings at each lower end of the side plate for supporting the U-shape work by axial rods inserted concentrically with the shaft holes. Further, at least one of the axial rods is a fold pin whereby one end of a shaft which is connectable and disconnectable to the axial hole and the connecting ring, is bendable. Consequently, disconnection is prevented when a front edge of the axial rod is in bending condition and at the same time, the axial rod can be connectable and disconnectable to the axial hole and the connecting ring by the front edge being horizontal along with the axial. Accordingly, inserting and detaching of the cargo handling member can be exercised more easily.

As the second means to solve the problem, the present invention employs a trolley construction, wherein a single-track suspension trolley for loading applied to a single rail, of which at least an upper half part is formed in arc shape, comprising: a bifurcated flame, of which upper end is open while both lower ends of symmetric arms are connected; a wheel having a pair of conical surfaces contacting with the upper half part of the rail at each point and pivoted to be revolvable to each upper end of the arms by the conical surface placing inward-looking; and a cargo handling member provided with the flame beneath the wheel. In this second means, unlike the first means adopting an integrated wheel, a wheel can be provided separately at right and left. As a clearance between right and left wheels is produced, pass of an obstacle is allowed with the clearance when the trolley moves. A conical surface of right and left wheel is to face, the trolley is suspended with the rail accessible in two points as with the first means.

In this second means, the flame connects lower ends of the arm able to turn and opening between upper ends of the arm is preferred to be adjustable. As a specific example of the adjustable opening mechanism, a threaded rod penetrates and screws in both arms.

Further, a wheel in the first and second means is preferred to form from material absorbing rolling sound and therefore, a synthetic resin is more preferred. Also, a hard rubber can be adopted. When the wheel is formed from synthetic resin or hard rubber, not only be a silent operation can exercised, but production efficiency heightens since a process is easier than metal.

As described above, as the present invention adopts the wheel accessible in two points with the arc shaped upper half part of the rail, a position can be changed in accordance with a diagonal or a lateral force other than a force of direction of movement, which results in an easy operation. Further, a problem such as breakage or failure is to decrease since unreasonable force is not put on the rail or the trolley. As the wheel is composed of a pair of cones connected to each other, a cone can be effectively produced by a molding compound art such as an injection molding. A cylindrical member wherein the V-shaped groove is prepared by carving can compose a wheel more easily as an assembly process of parts is not needed.

Further, as the present invention adopts another means for providing the wheel at right and left separately, when the trolley concerning to this means is applied to the rail composition suspended from a ceiling, a suspending member of the rail is to pass the clearance between right and left wheels and therefore, the trolley can move longer distance by avoiding an obstacle by the suspending member. Also, in this means, an upper opening of the arm is adjustable, a length of the clearance of a right and left wheels can be adjusted in accordance with a diameter of the rail.

Since the wheel is formed from a material such as a rubber and a synthetic resin, not only be productivity of a wheel can heightened but also a silent operation by sound absorption effect is promising in accordance with a prior molding art. Accordingly, a noise damage to a usage environment and an ambient surrounding cannot be occurred.

Additional objects and advantages of the present invention are apparent from the following detailed description of preferred embodiments thereof, which are best understood with reference to the accompanying drawings.

### BRIEF DESCRIPTION OF THE DRAWINGS

FIG. 1 is a front view of a trolley related to one embodiment of the present invention.

FIG. 2 is a side view of the trolley.

FIG. 3 is a front view showing the trolley in use (rotating state).

FIG. 4 is a front view showing the trolley in use (turning state).

FIG. 5 is a front view showing a rail condition applied to the trolley.

FIG. 6 is an explanatory view showing a wheel constitutional example.

FIG. 7 is an explanatory view showing another wheel constitutional example.

FIG. 8 is a front view of a substantial part section showing another constitutional example of a cargo handling member

FIG. 9 is a side view of the FIG. 8.

FIG. 10 is a front view of a trolley related to the second embodiment of the present invention.

FIG. 11 is a front view of a trolley related to the third embodiment of the present invention.

### DETAILED DESCRIPTION OF THE INVENTION

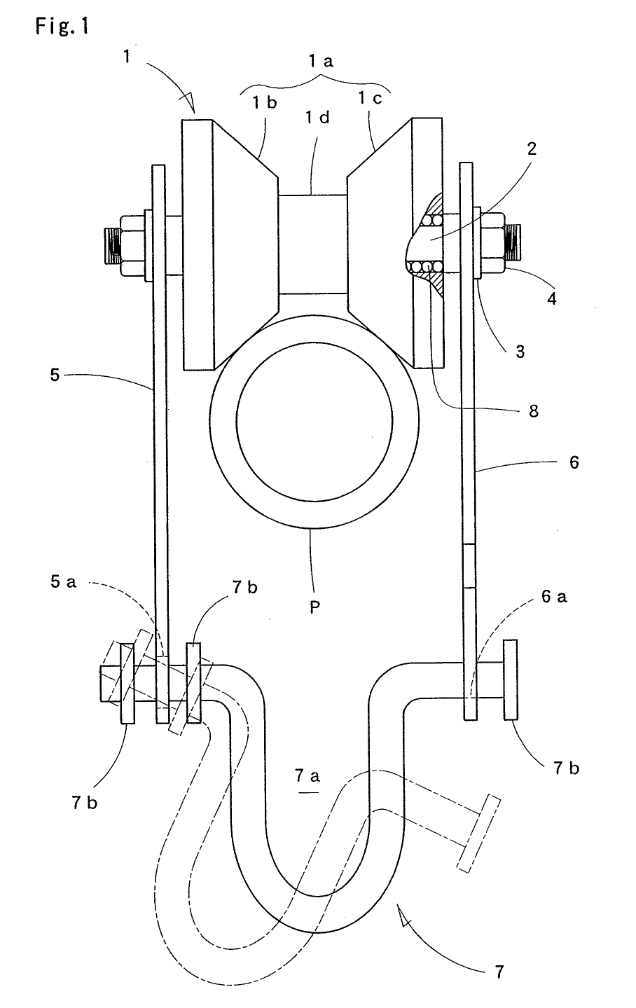

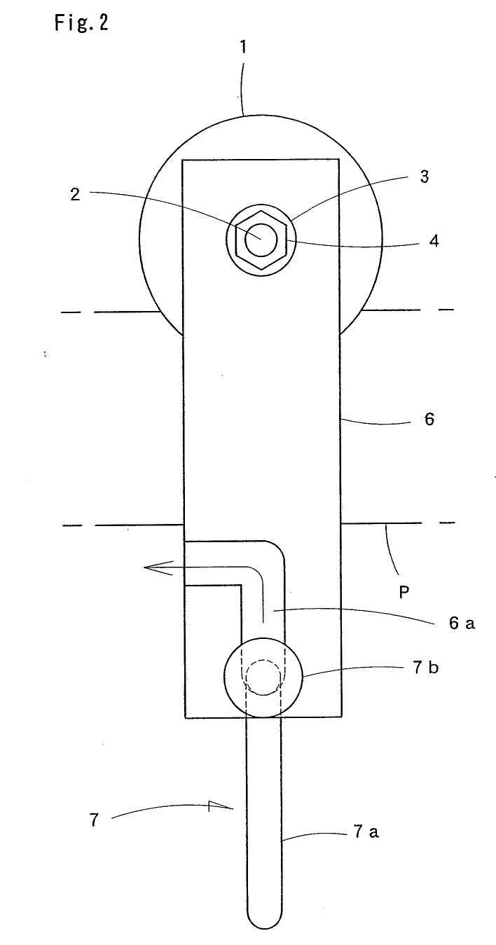

Hereinafter, preferred embodiments of the present invention will be described with referent to attached drawings. FIGS. 1 and 2 show a trolley relating to one embodiment of the present invention. In this trolley, both bolt heads in a rotary axis 2 of a wheel 1 is fixed to side plates 5 and 6 by a nut 4 through a washer 3, and a U-shaped cargo handling member 7 is attached and placed below the wheel 1. The side plates 5 and 6 are consisted of two metallic plates and a flame is consisted of these two side plates 5 and 6 in the present embodiment. However, a C-shaped flame can be composed by connecting with a horizontal plate to an upper border of plates.

The wheel 1 has a drum-like appearance having a V-shaped groove la at a center. The V-shaped groove la has symmetric taper planes 1b and 1c inclining to a center at right and left. In this embodiment, the V-shaped groove la has a horizontal plane 1d between the taper planes 1b and 1c. Also, the rotary axis 2 is inserted through a bearing 8 in the wheel 1 and the wheel 1 can be turned smoothly on the rotary axis 2 with the present composition.

The cargo handling member 7, in this embodiment, forms a depressed portion 7a for a retainer by bending in a U-shape a center of one metallic rod and also forms a flange 7b for retaining at both ends thereof. An attaching constitution of both ends of the cargo handling member 7 differs from the side plate 5 to the side plate 6. A circular hole 5a is provided through the side plate 5. On the other hand, a L-shaped guide groove 6a is formed visibly at a lateral side of the side plate 6. (refer to FIG. 2) Accordingly, the cargo handling member 7 is attached not to emerge one end thereof from the circular hole 5a while the other end is attached detachably along the guide groove 6a. Therefore, as shown with a dashed dotted line in the FIG. 1, the depressed portion 7a of the cargo handling member 7 can be open with one end detached from the side plate 6 and a ringed suspension member can be hanged to the depressed portion 7a. A hoist or a chain block can be an example for the suspension member to hang the cargo handling member 7. However, the member is not limited to the above. Also, a cargo hoisted and transferred is not limited as long as a withstand load is kept.

According to the trolley with the above composition, a cargo can be transferred to a long direction in a hoisted situation by using a circular pipe P as a rail by placing the wheel 1 on the circular pipe P. In this case, the wheel 1 is placed on an upper half part of the circular pipe P with two point-contact. Accordingly, the trolley can be operated with a light force since a contact face is less and friction resistance becomes small.

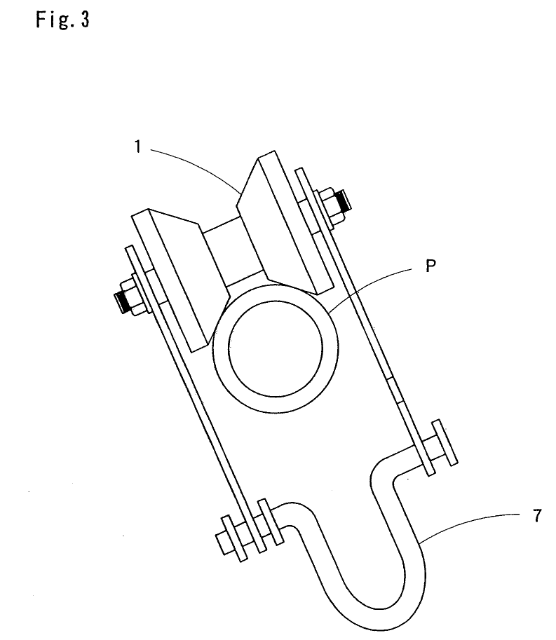

Even when a diagonal or a lateral force is acted, as shown in FIG. 3, a rolling position can be taken with a circular pipe P as an axis of rotation and therefore, flexibility of cargo handling operation expands. An unreasonable force is not to be put on the trolley or the rail when a force other than a direction of movement along with the rail is acted.

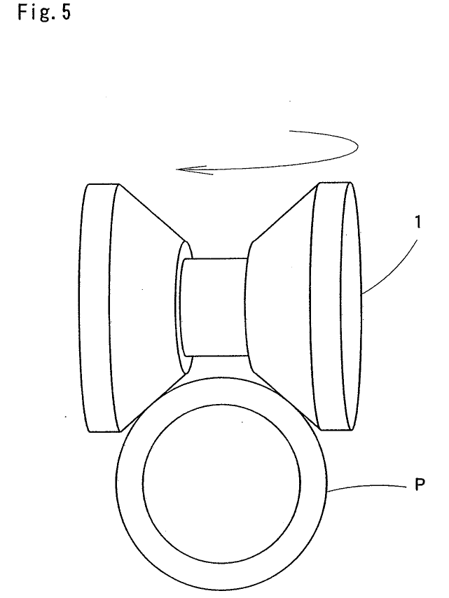

Further, when a twisting force is acted on the trolley, as shown in FIG. 5, the trolley can comply three-dimensionally with a force of any direction since the wheel 1 is supported by contacting in two points.

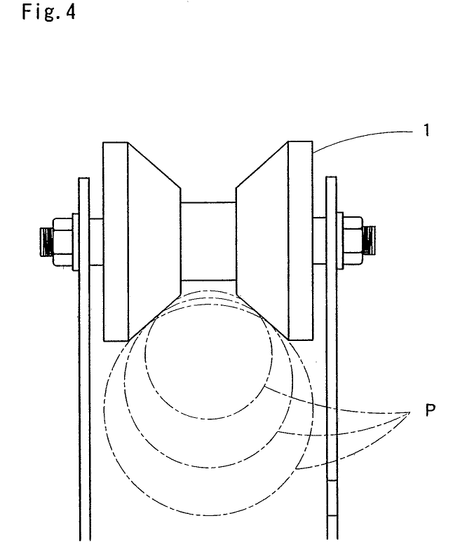

Furthermore, as shown in FIG. 4, as the wheel 1 can be applied to the circular pipe P having different diameter, a versatility is heightened.

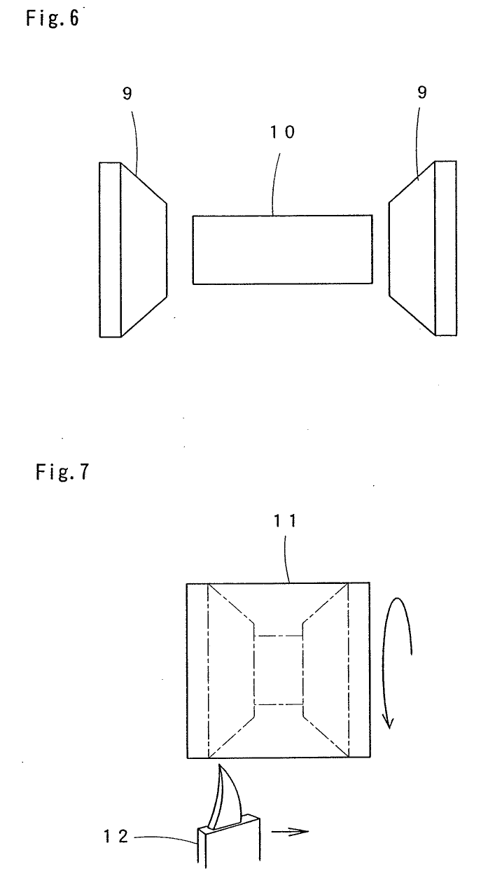

The wheel 1 as shown in FIG. 6, is composed of a pair of circular truncated cones 9 and 9, each of which circular conical surface is facing each other by being connected with a coupling rod 10. Also, as shown FIG. 7, the wheel 1 can be composed of a cylindrical member 11 by rolling and carving thereof to produce the V-shaped groove using a cutter 12. As to the V-shaped groove, producing a horizontal plane between taper planes is voluntary.

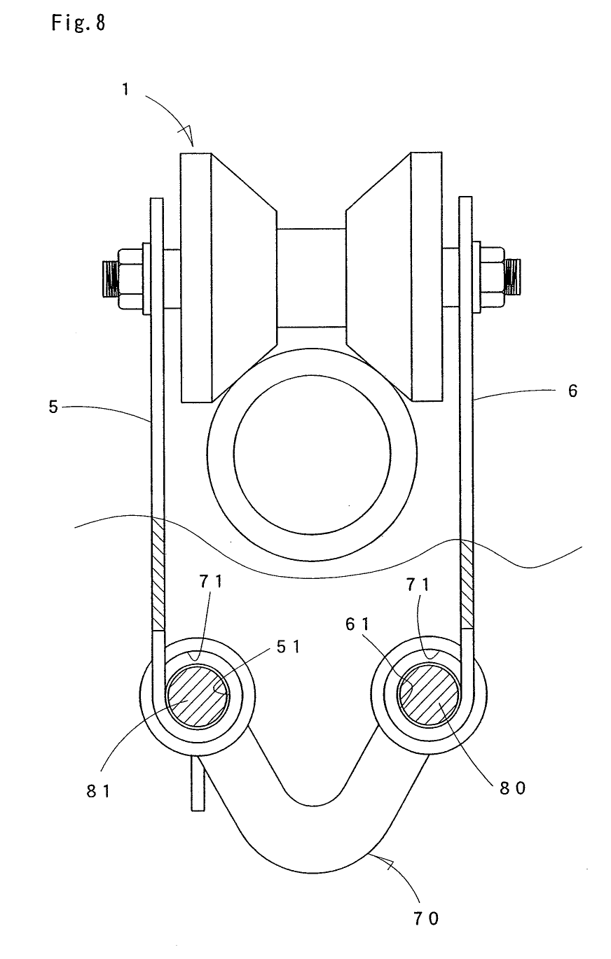

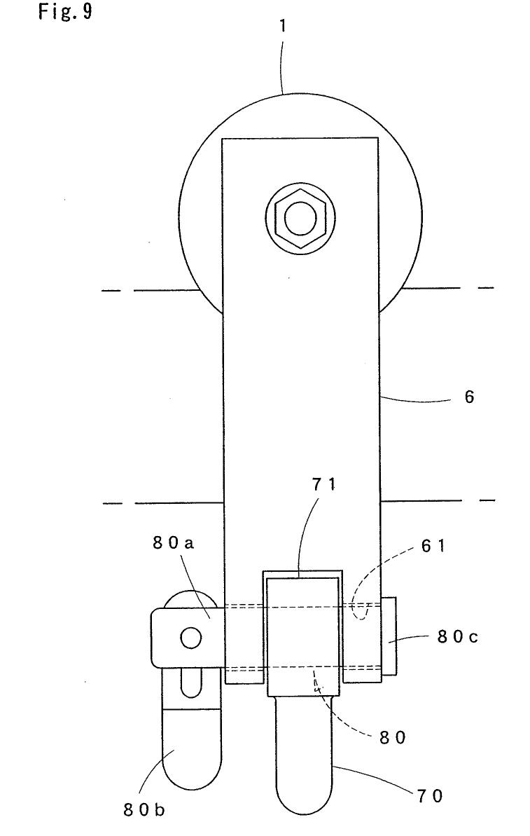

FIG. 8 shows another constitution of a cargo handling member supporting a U-shaped work 70 by axis rods 80 and 81 at a lower end of side plates 5 and 6. The U-shaped work 70 is formed into a U shape by bending downwards a center of a metallic rod and axis holes 71 for being penetrated by the axis rods 80 and 81 are formed in both ends thereof The side plates 5 and 6 having bending work in a circular manner at lower ends thereof forms connecting rings 51 and 61 able to support the U-shaped work 70 by inserting the axis rods 80 and 81 in the axis hole. Further, in this constitution example, as shown FIG. 9, the axis rod 80 is composed of a fold pin. This fold pin (the axis rod 80) is composed of a shaft 80a and a retaining axis 80b provided to be bended to a right angle at one end of the shaft 80a. The shaft 80a comprises a retaining plate 80c attached to the other end thereof Accordingly, in a state of the U-shaped work 70 being supported, the axis rod 80 can maintain a supporting condition without dropping off by the retaining axis 80b at right angles to the shaft 80a while the axis rod 80 can be taken out and put in the axial hole 71 and the connecting ring 61 by leveling the retaining axis 80b to the shaft 80a. In a state of the axis rod 80 being taken out, the side plates 5 and 6 can be open since the U-shaped work 70 is able to rotate in a cantilever state. The other axis rod 81 can be a fold pin.

As a rail laying constitution applied to the trolley in the present invention, a stand laying type whereby the rail is supported with a strut and a suspended laying type whereby the rail is suspended from a ceiling by a suspending member such as a bracket can be considered. When the trolley in the above embodiment is applied to a rail constitution of the stand laying type, the trolley is to be transferred only between struts as the struts is to be obstacles.

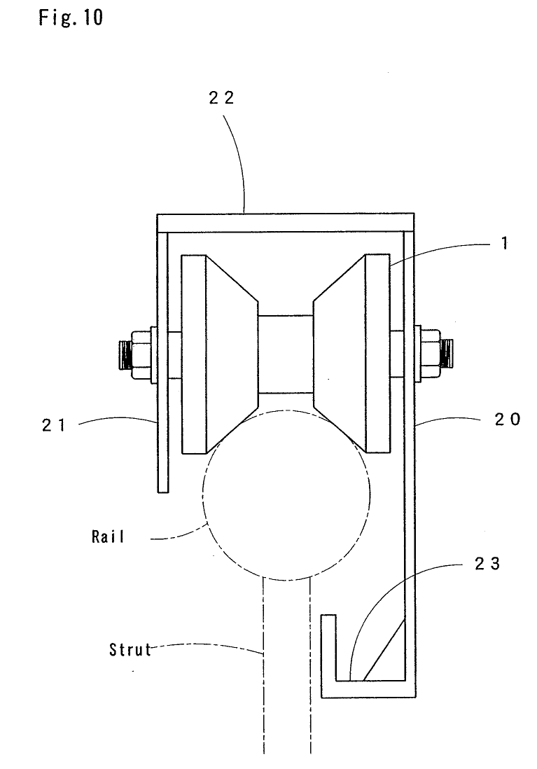

Therefore, FIG. 10 shows the second embodiment which can prevent the obstacle of a strut and a trolley can move throughout a laying in a rail constitution of a stand laying type. The trolley in this second embodiment is composed of a wheel 1 adopted in the first embodiment, side plates 20 and 21 at right and left enabling the wheel 1 to rotate, a horizontal member 22 connecting upper ends of the side plates 20 and 21 and a cargo handling member 23 provided at a lower end of the side plate 20. Especially, the trolley is characterized by a flame open at a lower part by connecting upper ends by the horizontal member 22. Accordingly, since an opening at lower part of a flame functions as a passage space of a strut, the strut is not to be an obstacle and the trolley can be transferred liberally throughout the rail. The cargo handling member 23 is provided in the side plate 20 and therefore, a center of gravity of the trolley is off to the side plate 20. However, this problem can be resolved by bending the lower half part of the side plate 20 inward to the center of gravity and providing a cargo handling member 23 at an extended line and/or holing a load equivalent to a weight of the cargo handling member 23 at the side plate 21.

Considering a withstand load such as a deflection and a damage of a rail at a handling time, the rail is preferred to support by a short span. However, in a case of the rail constitution of a stand laying type, when the strut is built in a short span, a working space on the ground decreases as many space as struts built. On the other hand, as a rail constitution of a suspended laying type does not have such demerit, a working space on the ground is unaffected even when an attaching span of a suspending member is shortened.

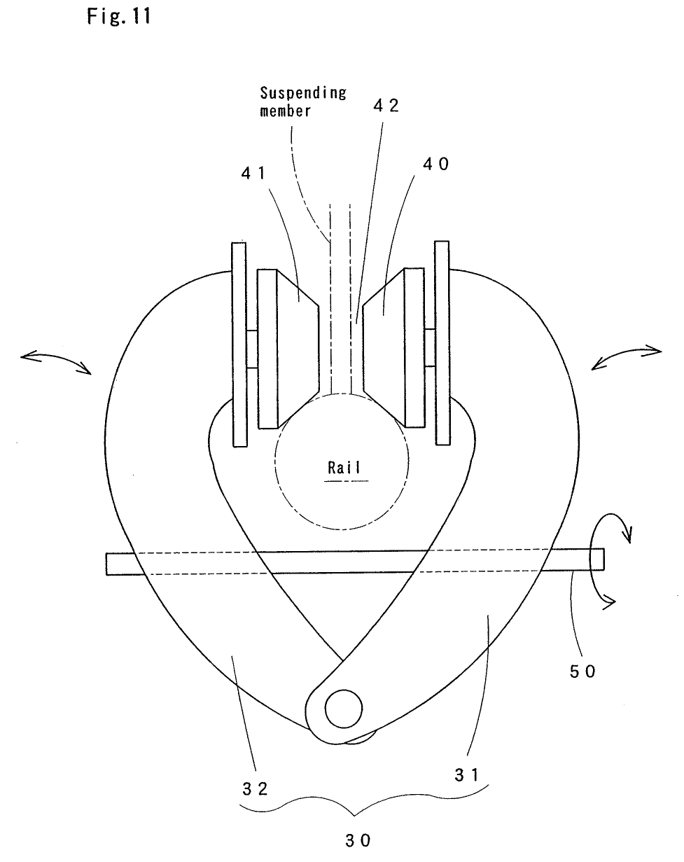

FIG. 11 shows the third embodiment applied to a rail constitution of a suspended laying type. In a trolley in this third embodiment, a flame 30 connects lower ends of symmetric arms 31 and 32 rotatably and opening of an upper end of the arm is adjustable. Circular truncated cone wheels 40 and 41 are provided rotatably on each upper end of arms of the flame 30. More specifically, the wheels 40 and 41 making each circular conical surface inward to contact with a rail in a point are pivoted at upper ends of the arm by segregating the wheels 40 and 41 with a clearance 42. In other words, compared to the first and the second embodiments adopting an integrated wheel connected with a pair of circular conical cone piece by an intermediate axis (horizontal plane 1d in FIG. 1), this third embodiment adopts a decoupled wheel omitting the intermediate axis from the integrated wheel. In this embodiment, a threaded rod 50 is penetrated between the arms 31 and 32 and a distance of the arms 31 and 32 expands and contracts by rotating the threaded rod 50. As a result, opening of an upper end of the arm is adjustable and therefore, the clearance 42 between the wheels 40 and 41 can be adjusted. In this embodiment, a combined area formed concave at a lower end of the arm is planed to be a cargo handling member and a hook for suspending a load is to be latched in the combined area. However, a cargo handling member of another member from the arms 31 and 32 can be provided in the flame 30.

According to the trolley in the third embodiment of the above composition, a rolling motion and the same functions explained on FIGS. 3 to 5 can be obtained by two-point contact by the wheel 40 and 41. Further, when the trolley is applied to a rail constitution of a suspending laying type, the trolley can be transferred throughout the rail since a suspending member can pass through the clearance 42 between the wheels 40 and 41 preventing the suspending member being an obstacle. This trolley in the third embodiment can be applied to the rail constitution of the stand laying type and the trolley can move between struts like the first embodiment.

Although in a handling state, a force to isolate the wheels 40 and 41 is put on the flame 30, the trolley is not dropped off from the rail since the thread rod 50 is penetrated in a screwed state into the arms 31 and 32, the clearance 42 between the wheels 40 and 41 is stabilized. On the other hand, as stated above, rotating the thread rod 50 enables to adjust the clearance 42 of the wheel 40 and 41 along with adjustment of the opening of the upper end of the arm, and therefore, when the trolley cannot be suspended from an end of the rail such as the rail with a closed-loop constitution, the rail is inserted by expanding the clearance 42 by a rotation operation of the thread rod 50. Afterwards, rotating the thread rod 50 in a reverse direction can restore a position of the trolley holding the rail not to be dropped off.

A rotating handle can be provided at an end of the thread rod 50 for rotating operation thereof. However, a center of gravity is to change for a weight of the rotating handle and the trolley cannot be kept in a horizontal position. Therefore, the rotating handle may be removable to the thread rod 50 or utilizing another member is preferred to compose to rotate the thread rod 50. Further, when a working load is for example, from 0.5 ton to 1.0 ton, the wheels 40 and 41 are preferred to be formed by iron having higher strength than synthetic resin.

It will be obvious to those having skill in the art that many changes may be made in the above-described details of the preferred embodiments of the present invention. The scope of the present invention, therefore, should be determined by the following claims.

What is claimed is:

1. A single-track suspension trolley for loading applied to a single rail, of which at least an upper half part is formed in arc shape, comprising:
a flame which has a drum-shaped wheel having a V-shaped groove provided at a middle portion thereof to be contact in two points with said upper half part of said rail and running on said rail, and a pair of side plates supporting said wheel rotationally; and
a cargo handling member provided with said flame beneath said wheel.

2. A trolley for loading according to claim 1, wherein said V-shaped groove has symmetric taper planes and a horizontal plane between said taper planes.

3. A trolley for loading according to claim 1, wherein said wheel is formed by a pair of cones connected integrally with conical surfaces of said cones faced each other.

4. A trolley for loading according to claim 1, wherein
said flame has a horizontal member connecting upper ends of said side plates providing an opening at lower part thereof, and
said cargo handling member is provided at a lower end of one of said side plates.

5. A trolley for loading according to claim 1, wherein
said cargo handling member has a depressed portion formed by bending a center of a rod, and
one end of said cargo handling member is attached detachably to one of said side plates of said flame enabling said depressed portion to be openable.

6. A trolley for loading according to claim 1, wherein
said cargo handling member comprises a piece of U-shaped work providing shaft holes at both ends thereof,
said flame comprises connecting rings at each lower end of said side plate for supporting said U-shape work by axial rods inserted concentrically with said shaft holes, and
at least one of said axial rods is a fold pin whereby one end of a shaft which is connectable and disconnectable to said axial hole and said connecting ring, is bendable.

7. A single-track suspension trolley for loading applied to a single rail, of which at least an upper half part is formed in arc shape, comprising:
a bifurcated flame, of which upper end is open while both lower ends of symmetric arms are connected;
a wheel having a pair of conical surfaces contacting with said upper half part of said rail at each point and pivoted to be revolvable to each upper end of said arms by said conical surface placing inward-looking; and
a cargo handling member provided with said flame beneath said wheel.

8. A trolley for loading according to claim 7, wherein said flame connects lower ends of said arms able to turn and opening between upper ends of said arms is adjustable.

9. A trolley for loading according to claim 8, wherein said flame has a threaded rod penetrating and screwing in both arms.

10. A trolley for loading according to claim 8, wherein said wheel is formed from a synthetic resin or a hard rubber.

11. A trolley for loading according to claim 1, wherein said wheel is formed from a synthetic resin or a hard rubber.
